(19) United States
(12) Patent Application Publication
(10) Pub. No.: US 2006/0237922 A1
(43) Pub. Date: Oct. 26, 2006

(54) MECHANIC'S CREEPER

(75) Inventor: Charlie L. Forbis, Quapaw, OK (US)

Correspondence Address: HOVEY WILLIAMS LLP, 2405 GRAND BLVD., SUITE 400, KANSAS CITY, MO, 64108, US

(73) Assignee: BLITZ U.S.A., INC., Miami, OK (US)

(21) Appl. No.: 10/907,908

(22) Filed: Apr. 20, 2005

(51) Int. Cl. B25H 5/00; B62B 11/00

(52) U.S. Cl. 280/32.6

(57) ABSTRACT

A mechanic's creeper is disclosed as including a body along with a fixed wheel assembly, a caster wheel assembly and a brake assembly coupled to the body. The body has a middle section with a fixed wheel assembly positioned below and end sections, separated by the middle section, with the caster wheel and brake assemblies positioned below separate end sections. The creeper has a rolling and turning mechanism where one end section is forced down to engage the fixed wheel and caster wheel assemblies with the ground. The creeper also has a braking mechanism where the other end section is forced down to engage the fixed wheel and brake assemblies with the ground.

### FIELD OF THE INVENTION

The present invention relates generally to mechanic's creepers. More specifically, the present invention concerns a mechanic's creeper with a body that both pivots and rotates about a fixed axis wheel assembly to enable a user to shift his weight to brake the creeper or turn the creeper along a zero turn radius.

### DISCUSSION OF PRIOR ART

Mechanics or other people who work in a confined space along a floor, such as under a vehicle, often have a need to be supported above the floor yet move along the floor to accomplish their work. It is known in the art to utilize a creeper to perform these functions. Prior art creepers support the user in a prone position and typically include multiple casters positioned around the periphery of the creeper body to enable both translational and rotational movement of the creeper.

These prior art, caster-supported creepers are problematic and all suffer from undesirable limitations. One limitation of these creepers is a broad freedom of lateral motion. This motion becomes a limitation because it makes these prior art creepers difficult to control. For example, many prior art creepers employ four casters spaced at corners of a rectangular body. Each caster is allowed to move in any horizontal direction and to rotate about an upright axis. In combination, the casters allow the body to translate in any direction and rotate about any point on the body. This configuration is problematic for most users, such as automobile mechanics, welders, pipe fitters, etc. because these users work with both of their hands engaged in a task. However, the user must normally place at least one hand or foot on the floor beneath the creeper to control it. If only one hand or foot is placed on the floor, then the creeper remains free to pivot about the hand or foot. Where a user places two hands or feet on the floor, the user can more positively limit translational and rotational movement of these creepers. However, precise control is difficult to achieve. This difficulty comes from the freedom of movement provided by casters that each permit rotation and lateral movement. In particular, the rolling and turning friction inherent in each caster makes movement somewhat unpredictable. Other factors include irregular or pitched floors, the user's weight and strength, and the placement of the user's hands and feet on the floor relative to the creeper. As a result, users employed in a task with both hands cannot at the same time reliably control these creepers. For example, where a mechanic applies substantial force to a wrench to pry loose a rusted bolt, the mechanic may have to rely on his or her feet to counteract the force applied to the wrench in order to keep the creeper in a steady position. Mechanics who use these prior art creepers often have to apply a counteracting force against a wall or against a portion of the car above them to counter substantial forces being applied by their hands to a wrench. The user's feet may not always provide an adequate counteracting force in these situations.

Precise translational and rotational movements are also difficult to achieve for similar reasons. A mechanic often needs to view automobile components from a precise location. For example, oil filters are commonly found among other engine parts, hoses, wiring harnesses, etc. The mechanic must be able to finely position himself below the filter to see it and place his hands on it. Where the mechanic's hands are occupied with work, the mechanic must use his or her feet to finely position his head and upper body. This manner of control is difficult because the feet are disposed away from the head. Normally, the mechanic must stop working and use his hands to reposition his head or use his hands to reposition his head while he or she is working.

It is also known in the art to provide a braking mechanism for a creeper. While these braking mechanisms solve some of the problems identified above, they are problematic and suffer from several undesirable limitations. These prior art brakes all require the movement of a handle or activation device relative to the creeper body. Prior art creepers having these brakes are not desirable because they involve hand, foot, or other body movements separate from those used to move these creepers. For example, the creeper disclosed in U.S. Pat. No. 4,244,594 involves a creeper having a brake flap. To engage the brake flap, the mechanic must move his body relative to the creeper so that the flap is forced downward. This movement requires the user to grab the creeper with his hands and pull or push himself so that his lower torso rests on the flap. Mechanics or other users often need to work with their hands on an automobile or other object while keeping these prior art creepers steady. Therefore, these braking mechanisms may be complicated to engage while the user is performing tasks with both hands. These prior art braking mechanisms also make the creeper more complex mechanically and expensive to manufacture. Accordingly, there is a need for an improved creeper that does not suffer from these problems and limitations.

### SUMMARY OF THE INVENTION

The present invention provides an improved creeper that does not suffer from the problems and limitations of the prior art creepers detailed above. The inventive creeper enables a precise and controllable zero-turn-radius capability while providing the creeper with freedom to move in translational and rotational directions.

A first aspect of the present invention concerns a rocking creeper for supporting a user and adapted to move laterally over a surface. The creeper broadly includes a body operable to support the user and including opposite first and second end sections and a middle section disposed between the end sections, a first wheel assembly coupled to the middle section, a second wheel assembly coupled to the first end section, and a brake coupled to the second end section. The first wheel assembly includes a first rotatable wheel. The second wheel assembly includes a second rotatable wheel. The body is pivotal about the first wheel when the user is supported thereon and is operable to pivot when the user's weight sufficiently shifts relative to the first wheel. The body pivots about the first wheel between a rolling position and a braking position. When in the rolling position, the second wheel engages the surface and the brake is spaced from the surface. When in the braking position, the brake engages the surface and the second wheel is spaced from the surface.

A second aspect of the present invention concerns a mechanic's creeper for supporting a user and adapted to move laterally over a surface. The creeper broadly includes a body operable to support the user and including opposite end sections and a middle section disposed therebetween, a fixed wheel assembly coupled to the middle section, and a caster wheel assembly coupled to the middle section. The fixed wheel assembly includes a pair of wheels rotatable about a generally laterally extending common axis that is fixed relative to the body during use. The wheels cooperatively define therebetween a turning midpoint for the body. The caster wheel assembly includes a caster wheel rotatable about a generally laterally extending rotational axis and pivotable about an upright caster axis. The fixed wheel and caster wheel assemblies cooperate to provide turning movement of the body about the midpoint.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a top perspective view of a creeper constructed in accordance with a preferred embodiment of the present invention;

FIG. 2 is a bottom perspective assembly view of the creeper illustrated in FIG. 1, showing the fixed wheel assembly, the caster wheel assembly, and a portion of the brake assembly exploded away from the body;

FIG. 3 is a plan view of the creeper illustrated in FIGS. 1 and 2;

FIG. 4 is a side elevation view of the creeper illustrated in FIGS. 1-3, showing the creeper in the braking position;

FIG. 5 is an enlarged sectional view of the creeper taken generally along line 5-5 of FIG. 3, showing the creeper in the rolling position;

FIG. 5a is a greatly enlarged fragmentary sectional view, showing the slots of the bracket and the axle retained in one set of slots.

FIG. 6 is an enlarged sectional view of the creeper taken generally along line 6-6 of FIG. 5;

FIG. 7 is a greatly enlarged fragmentary sectional view of the creeper illustrated in FIGS. 1-6, showing the brake stop received in the brake housing; and

FIG. 8 is a top view of the creeper illustrated in FIGS. 1-7 shown rotated relative to FIG. 3 about a zero turn radius.

### DETAILED DESCRIPTION OF THE PREFERRED EMBODIMENTS

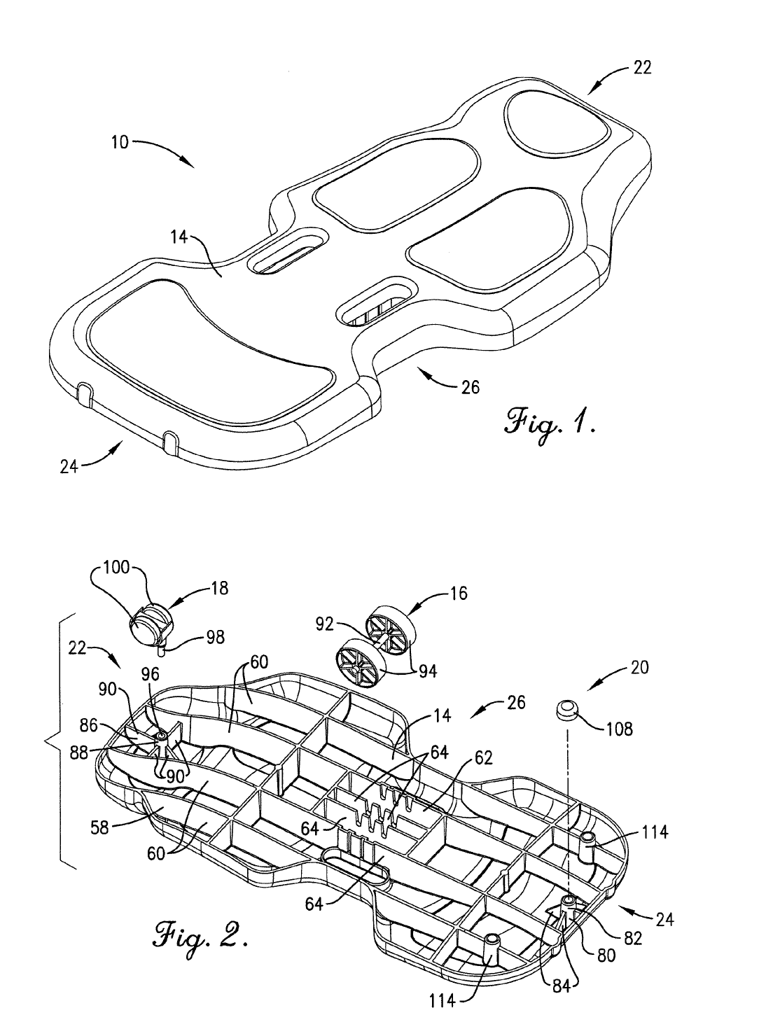

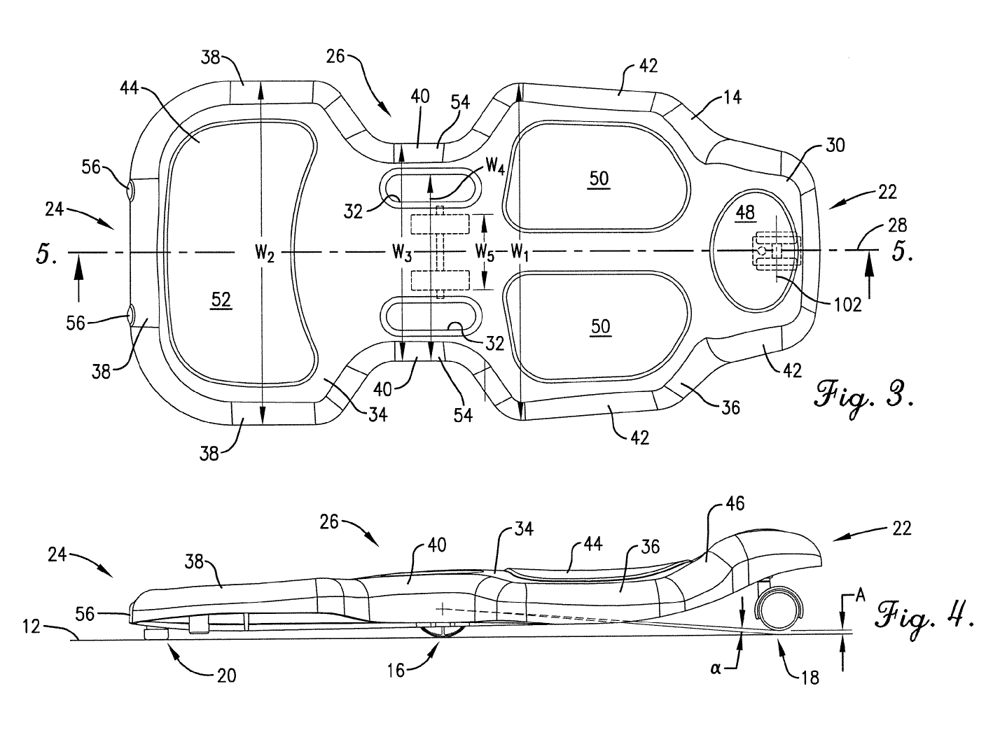

FIG. 1 illustrates a mechanic's creeper 10 constructed in accordance with a preferred embodiment of the present invention. The mechanic's creeper 10 is configured for supporting a user spaced from a surface 12 (shown in FIG. 4) and for allowing the user to move the creeper 10 relative to the surface 12. Although the creeper 10 is well suited for use by mechanics who work below an automobile undercarriage, the principles of the present invention are equally applicable to other applications where users work in a confined space proximate to a surface and require a mobile platform for supporting and moving the user relative to the surface. As shown in FIGS. 1 and 2, the illustrated mechanic's creeper 10 broadly includes a body 14, a fixed wheel assembly 16 adjustably coupled to the body 14, a caster wheel assembly 18, and a brake assembly 20.

As shown in FIGS. 1, 2 and 3, the body 14 supports the user. In more detail, the illustrated body 14 presents a caster end section 22 and a brake end section 24. Lying intermediate and interconnecting the end sections 22 and 24 is a middle section 26. The sections 22,24,26 are spaced along a longitudinal axis 28 (see FIG. 3) to give the body 14 an overall length of about 36 inches along the longitudinal axis 28 in a preferred embodiment. The longitudinal axis 28 denotes an axis of symmetry of the body 14. The illustrated configuration provides end sections 22, 24 that are roughly the same size. The middle section 26 is roughly spaced in the middle of the body 14 as measured along the longitudinal axis 28. More preferably, as measured along the longitudinal axis 28, the brake end section 24 has a length about ⅔ of the length of the caster end section 22, and the middle section 26 has a length from about ¼ to ⅓ of the overall length of the body 14.

As shown in FIG. 3, the widest portion of caster end section 22 has a width W1. In the preferred embodiment, the width W1 is about 18 inches. The brake end section 24 has a width W2, similar to W1. The middle section 26 has a width W3, about ⅔ the width W1. The width of the caster end section 22 gradually tapers down from the widest portion toward a head rest portion 30. The widths of each section give the body 14 an hourglass-type shape.

The body 14 further provides oval-shaped slotted holes 32 that extend vertically through the body 14. The slotted holes 32 also extend along the middle section 26, such that their long axis is parallel to the longitudinal axis 28. As will be discussed, the slotted holes 32 cooperate with the body 14 to provide handles for a user to grab or carry the creeper 10.

The end sections 22,24 are formed with the middle section 26 to create a body 14 that is continuous and rigid. The end sections 22,24 and the middle section 26 are formed of a rigid polymer material through a molding process. However, it is entirely consistent with the principles of the present invention that the sections 22,24,26 may be made of other materials such as wood, steel, or aluminum to form a rigid body.

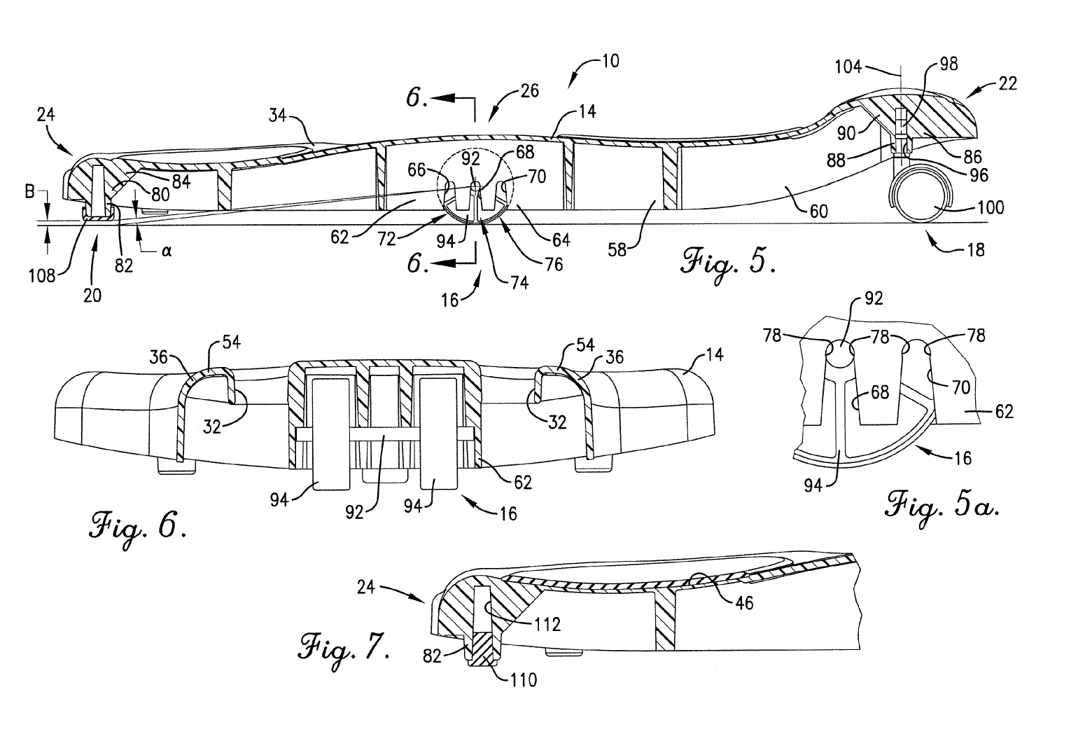

As seen in FIGS. 4 and 5, the illustrated body 14 presents a contoured outer surface 34 with a side elevation that roughly conforms to an adult user's shape. In particular, the end sections 22, 24 each have a concave shape to receive the user. The middle section 26 is convexly shaped to roughly conform with the arch of an adult user's back, providing a comfortable surface. The middle section 26 is also raised relative to the end sections 22, 24 to provide room for the fixed wheel assembly 16 while maintaining a relatively low profile of the body 14. The head rest portion 30 is convexly shaped and raised above the end sections 22, 24 and the middle section 26 to comfortably incline the user's head.

As illustrated in FIGS. 3 and 4, the contoured outer surface 34 has a rounded edge 36. The edge 36 includes lower torso edge portions 38, middle edge portions 40, and upper torso edge portions 42. The lower edge portions 38 define the width W2, while middle edge portions define the width W3. The upper torso edge portions 42 define the width W1 and the generally tapering width of the caster end section 22. In particular, the location and size of end sections 22, 24 and the middle section 26 are designed to conform to the user's size and shape, thus providing a comfortable support surface for extended use.

The body 14 also includes a cushioned layer 44 affixed to the body 14 by at least partially residing in a recessed portion 46 of the body 14 (see FIG. 7). The cushioned layer 44 presents a head rest surface 48, upper torso surfaces 50, and a lower torso surface 52. The lower torso surface 52 is located on the brake end section 24. The upper torso surfaces 50 are located on the caster end section 22. The head rest surface 48 is located on the head rest portion 30. The cushioned layer 44 provides a pliable surface, compared to the relatively rigid outer surface 34. The cushioned layer 44 therefore gives the user added comfort and support. The cushioned layer 44 may be molded onto the body 14. However, it is consistent with the principles of the present invention for the cushioned layer 44 to be molded or otherwise constructed separately from the body 14 and subsequently attached to the body 14.

The body 14 is configured to receive a prone-oriented user by receiving the user's head on the head rest surface 48, upper back on the upper torso surfaces 50, and portions of the user's body below the waist (e.g., hips, buttocks, and thighs) on the lower torso surface 52. As will be discussed later, the body 14 may be pivoted by arranging a user's weight on the surfaces 48, 50, 52. In the illustrated creeper 10, no portion of the cushioned layer 44 covers the middle section 26, although such a design is within the ambit of the present invention. One reason why the illustrated embodiment does not have the cushioned layer 44 covering the middle section 26 is that the cushioned layer 44 provides the user with a visual cue as to how the user's body will be oriented in operating the creeper 10. Also, the cushioned layer 44 defines optimal locations for the user to press against the body 14 and cause the body 14 to pivot around the fixed wheel assembly 16. The middle section 26 is proximate the fixed wheel assembly and therefore, does not provide an optimal surface for pivoting the body 14.

Turning to FIGS. 3 and 6, the body 14 also includes handles 54. The handles 54 are formed partly by the slotted holes 32 and the rounded edge 36. The slotted holes 32 are spaced within the middle section 26 and have an outer width W4 less than the width W3 and less than half of width W2. In the illustrated embodiment, the handles 54 are integrally molded with the body 14. Alternatively, the handles may be attached to the body 14, after the body 14 has been molded.

The body 14 further includes spaced apart projections 56 extending out from the brake end section 24. The projections 56 present a rounded outer surface. The projections 56 extend beyond the outermost edge of the brake end section 24 along the longitudinal axis 28. The projections 56 allow the creeper 10 to be stored vertically on the ground (i.e. the longitudinal axis 28 is arranged vertically) by engaging the ground while the brake end section 24 is adjacent to the ground. In this manner, the creeper 10 may be stored in a stable vertical position despite the creeper's generally contoured shape.

Various features of the body 14 discussed above, such as the handles 54 and the contoured outer surface 34, have been sized and arranged primarily for ornamental reasons. Therefore, the design of the body 14 may be revised or altered without departing from the scope of the present invention.

Turning to FIGS. 2 and 5, the body 14 includes a lower support structure 58 surrounded by the contoured outer surface 34 on the top and sides of the support structure 58. The support structure 58 extends along the body 14 and interconnects the end sections 22 and 24 as well as the middle section 26. The support structure 58 includes a plurality of laterally extending structural ribs 60 and an axle mounting bracket 62 projecting downwardly and inwardly from the outer surface 34. The bracket 62 is integrally formed with the body 14. The axle mounting bracket 62 is located within the middle section 26 and receives the fixed wheel assembly 16. The bracket 62 includes a plurality of longitudinally extending walls 64 that are integrally formed with the structural ribs 60. Each of the walls 64 include longitudinally spaced tapered slots 66, 68, 70 that create lower-most openings 72, 74, 76. As shown in FIG. 5a, the slots 66, 68, 70 are each defined to present opposing detents 78 that extend toward each other. The ribs 60 are integrally formed with the body 14, running along the length of the body 14 and along the width of the body 14. The ribs 60 are wall-like structural members that are preferably formed of a polymer material during a molding process.

The support structure 58 also preferably includes a brake housing 80 extending below the brake end section 24. The brake housing 80 includes a boss 82 molded into the support structure 58 with gussets 84 for rigidly attaching the boss 82 to the support structure 58. The support structure 58 includes a caster wheel housing 86 extending below the caster end section 22. The caster wheel housing 86 also includes a boss 88 molded into the support structure 58. Gussets 90 rigidly attach the boss 88 to the support structure 58.

Turning to FIGS. 2, 5, 5a and 6, the fixed wheel assembly 16 is coupled to the axle mounting bracket 62 on the body 14. As discussed previously, the preferred bracket 62 is integrally formed with the body 14 and is located within the middle section 26. The fixed wheel assembly 16 includes an axle 92 and a pair of rotatable wheels 94 proximate to each end of the axle 92. The rotatable wheels 94 have an outer width W5 about ⅓ of width W3 (see FIG. 3). The illustrated rotatable wheels 94 may rotate about the axle 92 but can also be fixed to the axle 92, in which case the axle 92 rotates within the bracket 62. The bracket 62 receives the fixed wheel assembly 16 through one of the openings 72,74,76 in one of the slots 66,68,70 (see FIG. 5). The detents 78 have end points that are spaced at a width less than the axle diameter, so that the axle 92 is removably retained in the respective one of the slots 66, 68, 70. In this manner, the axle 92 is orthogonally oriented relative to the longitudinal axis 28. The combination of slots 66, 68, 70 provide multiple locations for the axle 92 to be received by the bracket 62 along longitudinal axis 28. In the illustrated embodiment, the axle 92 is retained within slot 68.

Each of the locations, in combination with the fixed wheel assembly 16 received therein, allow the body 14 to freely pivot about the axle 92. In effect, the axle 92 becomes a fulcrum about which the body 14 pivots. The selectable axle location allows the axle 92 to be shifted relative to the body 14. In the illustrated embodiment, the axle 92 can only be shifted into and out of slots 66,68,70 with the user positioned off of the creeper 10. The selectable axle location also allows the axle 92 to be moved relative to a particular position of the user on the body 14. For example, if the user wants the brake end section 24 to be more firmly in contact with the surface 12, a user can shift his body weight from its original position toward the brake end section 24 to a new position. However, the user may be most comfortable in his original position on the body 14. The user, oriented in the original position, can place more weight on the brake end section 24 by moving the axle 92 relative to the body 14. This is accomplished by moving the axle 92 to one of slots 66, 68, 70 closer to the caster end section 22 (again, while the user is positioned off of the creeper 10). When the user returns to the original position, more body weight is placed on the side of axle 92 adjacent the brake end section 24 than before. As will be discussed in more detail, the user can change the axle 92 location to change the force required to pivot the creeper 10.

The creeper 10 also includes the caster wheel assembly 18, as shown in FIGS. 2 and 5. As previously discussed, the support structure 58 includes a caster wheel housing 86. The caster wheel housing 86 includes the boss 88 integrally molded with the support structure 58. The boss 88 has a bore 96 running partially through the boss 88. The caster wheel assembly 18 has a shaft 98 that is inserted into the bore 96. The boss 88 lies along the longitudinal axis 28. The caster wheel assembly 18 has two wheels 100 that freely rotate about a lateral axis 102 (see FIG. 3) and also an upright caster axis 104 aligned with the bore 96. The caster wheel assembly 18 is a commonly available component and easily integrated into the creeper 10 design.

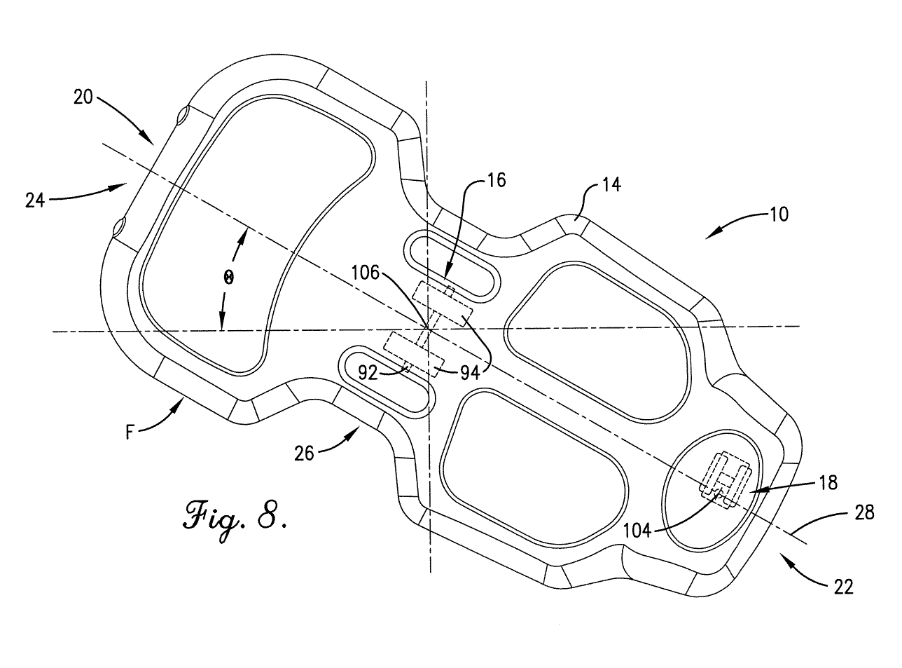

The unique turning operation of the creeper 10 is shown in FIGS. 3 and 8. The body 14, fixed wheel assembly 16, and caster wheel assembly 18 cooperate to provide the creeper 10 with a precise and controllable turning operation. The user applies a lateral force F with legs or arms to create a moment about the turning midpoint 106 (see FIG. 8). FIG. 8 illustrates a turned orientation of the creeper 10 relative to FIG. 3. In this turned orientation, the creeper 10 has been turned through an angle θ, which may be less than or greater than a full revolution. The body 14 turns about the midpoint 106 in response to the lateral force F and the caster wheel assembly 18 turns about the caster axis 104 to follow the caster end section 22. The rotatable wheels 94 of the fixed wheel assembly 16 cooperatively rotate about the axle 92 to allow the body 14 to turn about the midpoint 106. This illustrates a pure rotational movement of the body 14. Alternatively, note that the creeper 10 allows pure translational movement only along the longitudinal axis 28. The fixed wheel assembly 16 deliberately limits pure translational movement of the body 14 in other off-axis directions. Prior-art creepers using multiple caster wheels are known to allow pure translational movement in more than one direction. The creeper 10 must rotate when the lateral force F is applied orthogonal to the longitudinal axis 28. Components of force F parallel to longitudinal axis will subsequently provide translational movement along the axis 28. The fixed wheel assembly 16 of creeper 10 therefore allows the user to more precisely control translational and rotational movement because of how it limits translational movement. While limiting translational movement, the fixed wheel assembly 16 and the caster wheel assembly 18 of creeper 10 cooperate to provide a zero-turn-radius function that enhances the overall mobility of creeper 10. The illustrated turning operation is achieved without attaching wheels to each end of the creeper 10. Instead, the fixed wheel assembly 16 is attached below the middle section 26 and the caster wheel assembly 18 is attached below the caster end section 22, preferably leaving the brake end section 24 devoid of wheels.

Turning to FIGS. 2 and 5, the creeper 10 includes the brake assembly 20 with a brake housing 80. The brake housing 80 is attached to the support structure 58 and extends below the brake end section 24. As discussed previously, the support structure 58 includes a boss 82 integrally molded with the support structure 58. The boss 82 lies along the longitudinal axis 28. As shown in FIGS. 2 and 5, the brake assembly 20 includes a friction element in the form of a cap 108 that slides over the boss 82. The cap 108 is preferably made of an elastomer material, but it is consistent with the scope of the present invention that the cap 108 is made of some other high-friction material. In use, the brake assembly 20 is actuated by a user applying a braking force to the outer surface 34 proximate to the brake end section 24. As will be discussed later, the braking force must overcome other forces applied to the body 14, so that the body 14 pivots about the fixed wheel assembly 16 to place the friction element in contact with the surface 12.

As will be seen in FIGS. 4, 5, and 8, the creeper 10 provides a unique braking mechanism along with the unique turning mechanism described above. The body 14 pivots freely about the fixed wheel assembly 16. Moreover, the body 14, fixed wheel assembly 16, brake assembly 20, and caster wheel assembly 18 cooperate to provide the creeper 10 with discrete rolling and braking positions. As mentioned previously, the axle 92 may be installed in one of several locations along the axle mounting bracket 62. This also allows the axle 92 to be located relative to a particular user position on the body 14. In the illustrated embodiment, the axle 92 must be moved with the user positioned off of the creeper 10. However, it is within the scope of the present invention that the creeper 10 may be configured such that the axle 92 can be shifted relative to the body 14 while the user is positioned on the creeper 10. In this manner, the user can select one of the axle locations to change the force required to pivot the creeper 10 around the axle 92.

The braking position (shown in FIG. 4) is enabled when the user pivots the body 14 to apply more downward force on the side of axle 92 proximate to the brake end section 24 than on the side of axle 92 proximate to the caster end section 22. The body 14 pivots until the friction element of brake assembly 20 contacts the surface 12. In this position, the caster wheel assembly 18 is spaced above the surface 12 a distance A (preferably less than one inch and more preferably about one-quarter of an inch) and is rotated about an angle α (about one degree). The rolling position (shown in FIG. 5) is enabled when the user pivots the body 14 to apply more downward force on the side of axle 92 proximate to the caster end section 22 than on the side of axle 92 proximate to the brake end section 24. The body 14 pivots until the caster wheel assembly 18 contacts the surface 12. In this position, the brake assembly 20 is spaced above the surface 12 a distance B (preferably less than one inch and more preferably about one-quarter of an inch) and is also rotated about the angle α.

The creeper 10 with the discrete braking and rolling positions has numerous benefits. The positions are separated by a small angle of pivot about the axle 92. This small angle allows the user to maintain a low vertical profile relative to the surface irrespective of the creeper 10 position. With the previously discussed selectable fulcrum, the user can adjust the creeper 10 to require a desired leveraging force (applied by the user's legs) to more easily pivot the creeper 10 between the braking and rolling positions. Pivoting is primarily controlled by body weight and by force exerted by the user's legs. Therefore, discrete positions provide reliable control of braking and rolling with no use of the user's hands. The user is free to dedicate both of his or her hands to actions other than controlling the creeper 10. The precise control of braking also allows a user to apply more leverage with his or her hands to a work piece (not shown). With some prior-art creepers, users often can apply only limited leverage to a work piece. The user of such a creeper must normally apply at least one hand to a surface to prohibit lateral creeper movement. The braking position of creeper 10 provides a positive braking force and leaves the user's hands free to act on the work piece.

In operation, the user lies down onto the creeper 10 by sitting on the lower torso surface and reclining backward to place his or her back onto the upper torso surface 50 and his or her head onto the head rest surface 48. The user lays on the body 14 in a prone position and facing upwards. In this position, a majority of the user's weight is located on the side of axle 92 proximate to the brake end section 24. Therefore, the creeper 10 is normally in the braking position. The user pivots the creeper into the rolling position by pushing his or her feet down against the surface 12. The user continues to push harder with his or her feet until more weight is applied on the side of the axle 92 proximate the caster end section 22 than on the other side of the axle 92 and the caster wheel assembly 18 engages the surface 12. The user then uses his legs as necessary to apply a lateral force for translational or rotational movement of the creeper.

In the embodiment of FIG. 7, the friction element is an insert 110 that is partially disposed within a bore 112 of boss 82. In this alternative embodiment, the insert 110 contacts the surface 12. The insert 110 is preferably made of an elastomer material, but it is consistent with the scope of the present invention that the insert 110 is made of some other high-friction material.

In another alternative embodiment, shown in FIG. 2., alternative bosses 114 are provided in the brake assembly 20. These bosses 114 are molded integrally into the support structure 58, similar to boss 82. The bosses 114 are located symmetrically relative to the longitudinal axis 28 and also include a friction element (not shown) similar to cap 108 or insert 110.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A rocking creeper for supporting a user and adapted to move laterally over a surface, said rocking creeper comprising:
a body operable to support the user and including opposite first and second end sections and a middle section disposed therebetween;
a first wheel assembly coupled to the middle section, said first wheel assembly including a first rotatable wheel;
a second wheel assembly coupled to the first end section and including a second rotatable wheel; and
a brake coupled to the second end section,
said body pivotal about the first wheel when the user is supported thereon and operable to be pivoted when the user's weight sufficiently shifts relative to the first wheel,
said body pivotal about the first wheel between a rolling position, wherein the second wheel rollingly engages the surface and the brake is spaced from the surface, to allow the creeper to move laterally over the surface, and a braking position, wherein the brake engages the surface and the second wheel is spaced from the surface, to prevent the creeper from moving laterally over the surface.

2. The rocking creeper as claimed in claim 1,
said first rotatable wheel being coupled to an axle,
said axle being adjustably coupled to said body.

3. The rocking creeper as claimed in claim 2,
said axle being removably coupled to said body.

4. The rocking creeper as claimed in claim 3,
said body including an axle mounting bracket, said bracket including a plurality of longitudinally extending walls, said walls including a plurality of slots for coupling the axle in a plurality of positions relative to the body.

5. The rocking creeper as claimed in claim 4,
said body including a longitudinal axis parallel to said walls, wherein the slots are spaced longitudinally along the middle section.

6. The rocking creeper as claimed in claim 4,
said axle having opposing ends, wherein the slots are adapted to receive the opposing ends.

7. The rocking creeper as claimed in claim 1,
said body including a cushioned layer fixed to said body, said body constructed of a first material and said cushioned layer including a second material, said second material being more pliable than said first material.

8. The rocking creeper as claimed in claim 7,
said end sections each including a portion of the cushioned layer, said middle section being devoid of the cushioned layer to define spaced apart weight bearing surfaces.

9. The rocking creeper as claimed in claim 8,
said cushioned layer presenting a head rest surface adjacent to the first end section, an upper torso support surface between said head rest surface and the middle section, and a lower torso support surface adjacent to the second end section.

10. The rocking creeper as claimed in claim 1,
said body including a plurality of laterally extending structural ribs, said ribs rigidly interconnecting said end sections.

11. The rocking creeper as claimed in claim 10,
said ribs being integrally formed with said body by a plastic molding process.

12. The rocking creeper as claimed in claim 1,
said first rotatable wheel being coupled to an axle,
wherein said axle is fixed relative to the body.

13. The rocking creeper as claimed in claim 1,
said body including a handle spaced between the first and second end sections, said handle being at least partially formed by a slotted hole extending through said body.

14. A mechanic's creeper for supporting a user and adapted to move laterally over a surface, said mechanic's creeper comprising:
a body operable to support the user and including opposite end sections and a middle section disposed therebetween;
a fixed wheel assembly coupled to the middle section, said fixed wheel assembly including a pair of wheels rotatable about a generally laterally extending common axis that is fixed relative to the body during use, said wheels cooperatively defining therebetween a turning midpoint for the body; and
a caster wheel assembly coupled to one of the end sections and including a caster wheel rotatable about a generally laterally extending rotational axis and pivotable about an upright caster axis,
wherein said fixed wheel and caster wheel assemblies cooperate to provide turning movement of the body about the midpoint.

15. The mechanic's creeper as claimed in claim 14;
a brake coupled to the other end section,
said body pivotal about the fixed wheel assembly when the user is supported thereon and operable to be pivoted when the user's weight sufficiently shifts relative to the fixed wheel assembly,
said body pivotal about the fixed wheel assembly between a rolling position, wherein the caster wheel rollingly engages the surface and the brake is spaced from the surface, to allow the creeper to move laterally over the surface, and a braking position, wherein the brake engages the surface and the caster wheel is spaced from the surface, to prevent the creeper from moving laterally over the surface.

16. The mechanic's creeper as claimed in claim 14,
said fixed wheel assembly including an axle,
said axle being adjustably coupled to said body.

17. The mechanic's creeper as claimed in claim 16,
said body including an axle mounting bracket, said bracket including a plurality of longitudinally extending walls, said walls including a plurality of slots for coupling the axle in a plurality of positions relative to the body.

18. The mechanic's creeper as claimed in claim 17,
said body including a longitudinal axis parallel to said walls, wherein the slots are spaced longitudinally along the middle section.

19. The mechanic's creeper as claimed in claim 17,
said axle having opposing ends, wherein the slots are adapted to receive the opposing ends.

20. The mechanic's creeper as claimed in claim 14,
said body including a cushioned layer fixed to said body, said body constructed of a first material and said cushioned layer including a second material, said second material being more pliable than said first material.

21. The mechanic's creeper as claimed in claim 20,
said end sections each including a portion of the cushioned layer, said middle section being devoid of the cushioned layer to define spaced apart weight bearing surfaces.

22. The mechanic's creeper as claimed in claim 21,
said cushioned layer presenting a head rest surface adjacent to the first end section, an upper torso support surface between said head rest surface and the middle section, and a lower torso support surface adjacent to the second end section.

23. The rocking creeper as claimed in claim 14,
said body including a plurality of laterally extending structural ribs, said ribs rigidly interconnecting said end sections.

24. The rocking creeper as claimed in claim 23,
said ribs being integrally formed with said body by a plastic molding process.

25. The rocking creeper as claimed in claim 14,
said body including a handle spaced between the first and second end sections, said handle being at least partially formed by a slotted hole extending through said body.
